(19) United States
(12) Patent Application Publication
(10) Pub. No.: US 2007/0034655 A1
(43) Pub. Date: Feb. 15, 2007

(54) Pre-runner truck rack

(75) Inventor: Ron Storer, Villa Park, CA (US)

Correspondence Address: STETINA BRUNDA GARRED & BRUCKER, 75 ENTERPRISE, SUITE 250, ALISO VIEJO, CA, 92656, US

(73) Assignee: Xtreme Metal Fab., Inc.

(21) Appl. No.: 11/203,737

(22) Filed: Aug. 15, 2005

(51) Int. Cl. B60R 9/00; B62D 43/00; B60R 7/00

(52) U.S. Cl. 224/403; 224/42.13

(57) ABSTRACT

A modular rack is provided that is mountable to a vehicle. The vehicle includes a cargo bed and opposing side walls. The rack comprises a frame member, a pair of kickers, and at least one module. The frame member may be mountable to the side walls of the vehicle. The kickers may each define a top end that may be removably connectable to the frame member. The kickers may also each define a bottom end that may be removably mountable to the cargo bed. The module may be connectable to one of the frame member and the kickers. The module may be configured as a tire carrier, a tool case, and/or a panel for mounting or carrying accessories such as lights.

### CROSS-REFERENCE TO RELATED APPLICATIONS

The present application claims priority to U.S. application Ser. No. 10/770,214 filed on Feb. 2, 2004, and to U.S. Design Pat. No. D493,414, filed on May 8, 2003.

### STATEMENT RE: FEDERALLY SPONSORED RESEARCH/DEVELOPMENT

Not Applicable

### BACKGROUND

The present invention relates in general to a truck sports rack and, more particularly, to a truck sports rack that can be dissembled in pieces for shipment and quickly reassembled for such that it may be mounted on a truck.

Several truck racks have been developed for use on a cargo bed of a truck. Many of these racks include “roll bars” to provide further protection for the driver and passengers of the truck in case of a rollover accident. Typically, such racks are of heavy gauge metal and may be very bulky in order to withstand possible impact and crushing forces. This type of construction may make it very difficult for an inexperienced individual to install the rack. Further, such racks often require at least modest, if not significant and/or permanent, alterations to the truck bed in order to facilitate the installation of the rack. Thus, it often becomes very difficult to install or remove the rack without additional help from an expert or professional skilled in the art. This additional burden falls onto the shoulders of the user, and often results in increased cost and time.

In addition, many prior art truck racks are provided as a unitary structure of welded construction. Such truck racks suffer from several deficiencies that detract from their overall utility. For example, truck racks that are provided as a welded construction result in a relatively large structure. Unfortunately, such truck racks must be provided in a relatively large variety of sizes in order to accommodate the wide variety of cargo bed geometries that are available from the various truck manufacturers. In addition, the cost of shipping such truck racks from the manufacturer to retailers is relatively high due to the bulkiness of such truck racks. Furthermore, the cost of storing the truck racks and displaying the truck racks is also relatively large due to the large amount of space required. Such costs are ultimately passed on to the purchaser.

Furthermore, as similarly mentioned above, the unitary construction of these racks also tends to complicate the installation and/or removal of such racks. In particular, after welding, the rack becomes a bulky, heavy unitary structure that must be carefully handled. As mentioned above, such handling cannot often be done with only one person. Therefore, the rack must be installed or removed with the efforts of several people. In addition, the overall weight of such racks may also adversely affect the handling of the truck.

The mounting mechanism of many truck racks may allow for either permanent or removable mounting. However, these racks often also require specialized mounting mechanisms that comprise several elements. Frequently, none of these racks are easily mountable due to the relatively large number of mounting components and the large number of fasteners to interconnect such mounting components. As mentioned above, most of these racks are constructed of relatively heavy bar, tubing or frame members which increases the difficulty of mounting and/or removing the rack from the truck.

Finally, although these racks often enhance the safety of the truck on which they are, used, such racks often fail to provide other useful advantages. Many truck racks have been modified to incorporate optional lights. However, other accessories or utilities may not be incorporated among common racks without great expense or modification. Thus, it appears that the functionality of such racks has been fundamentally limited to the above-mentioned uses.

Therefore, there exists a need in the art for a truck rack that may be assembled from a set of components such that the truck rack may be shipped in pieces and re-assembled by the ultimate purchaser. Also, there exists a need in the art for a truck rack that is easily adaptable for mounting to a wide variety of cargo beds of varying geometry. In addition, there exists a need in the art for a truck rack that can be readily mounted to a wide variety of pickup trucks using only a few types of mounting mechanisms. Furthermore, there exists a need in the art for a truck rack that is lightweight and strong such that minimal effort is required to mount and demount the rack while the rack can support heavy weight. Additionally, there exists a need in the art for a rack that utilizes interchangeable components that may facilitate additional functionality of the rack. Finally, there exists a need in the art for a truck rack that is of simple construction with a relatively small number of components such that the overall cost of the truck rack may be minimized.

### BRIEF SUMMARY

In accordance with an embodiment of the present invention, a modular rack is provided that is mountable to a vehicle. The vehicle includes a cargo bed and opposing side walls. The rack comprises a frame member, a pair of kickers, and at least one module. The frame member may be mountable to the side walls. The kickers may each define top and bottom ends. The top ends may each be removably connectable to the frame member, and the bottom ends may each be removably mountable to the cargo bed. The module may be connectable to one of the frame member and the kickers.

The kickers may further define a plurality of mounting positions between the top and bottom ends. Thus, the module may be positionable at one of the mounting positions and may be removably connectable thereto. The module may be a tire carrier. Additionally, the module may be an accessory panel being connectable to the frame member. The frame member may be configured to include a pair of hoops that are positioned parallel relative to each other, and the accessory panel may be extendable intermediate the hoops and connectable thereto. According to an implementation of the present invention, the kickers may be channeled. In fact, the kickers may be configured to include a pair of base brackets disposed at the bottom ends thereof. Each of the base brackets may be connectable to the bottom ends of the kickers and may be mountable to the cargo bed. Finally, the frame member and the kickers may each be perforated with a plurality of apertures.

According to another embodiment of the present invention, a modular rack is provided that is mountable to a vehicle. The vehicle includes a cargo bed and opposing side walls. The rack comprises a frame member, a pair of kickers, and a tire carrier. The frame member may be mountable to the side walls. The kickers may each define a top end, a bottom end, and a plurality of mounting positions between the top and bottom ends. The top ends may each be removably connectable to the frame member, and the bottom ends may each be removably mountable to the cargo bed. The tire carrier may be selectively positionable between the kickers at one of the mounting positions and may be removably connectable thereto.

In accordance with another implementation of the present invention, the mounting positions may be defined by a plurality of adjustment holes. Additionally, the kickers may be channeled. Further, the cargo bed may include a front wall interposed between the side walls. In this regard, the frame member may be vertically positioned adjacent the front wall.

The frame member may also define opposing ends and include a pair of stake mounts extending downwardly from the opposing ends. The frame member may include a pair of base plates and a pair of clamps. The base plates may be disposed at opposing ends of the frame member and may be rigidly connectable thereto. The clamps may extend over the respective ones of the base plates and may be sized and configured to clamp the base plates to the side walls. In addition, the base plates may each include a lip protruding perpendicularly therefrom. The clamps may be C-shaped and sized and configured to extend over the lip and to clamp the base plates to the side walls. Each one of the C-shaped clamps may include upper and lower clamp members being connectable to each other. The upper and lower clamp members may be adjustable relative to each other with the side wall and the BASE BRACKET being capturable between the upper and lower clamp members.

In accordance with yet another embodiment of the present invention, a rack mountable to a vehicle is provided. The vehicle includes a front wall, a cargo bed and opposing side walls. The rack comprises a frame member, at least two channeled kickers, a pair of base brackets, and at least one module. The frame member may be mountable to the vehicle over the front wall and extendable between the side walls. The channeled kickers may each define top and bottom ends. The top ends may each be removably connectable to the frame member. The bottom ends may each be removably mountable to the cargo bed. The base brackets may be connectable to the kickers at the respective bottom ends thereof. The base brackets may be mountable to the cargo bed. The module may be connectable to one of the frame member and the kickers.

The kickers may further define a plurality of mounting positions between the top and bottom ends. In this regard, the module may be positionable at one of the mounting positions and may be removably connectable thereto. The module may be a tire carrier. The module may be an accessory panel being connectable to the frame member.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a rack in accordance with an embodiment of the present invention as installed on a truck illustrating the interconnectivity of a frame member and kickers that make up the rack;

FIG. 2 is a perspective view of the rack showing an optional module installed thereon, which module is shown as being configured to be a tire carrier in accordance with another embodiment of the present invention;

FIG. 3 is a perspective view of an opposing end of the frame member illustrating a stake mount for installing the rack in accordance with another embodiment of the present invention;

FIG. 4 is a perspective view of a clamp as may used for mounting the rack to the truck in accordance with another embodiment of the present invention; and

FIG. 5 is a cross-sectional view of a C-shaped clamp having upper and lower clamp members for clamping the rack to a side wall of the truck in accordance with another embodiment of the present invention.

### DETAILED DESCRIPTION

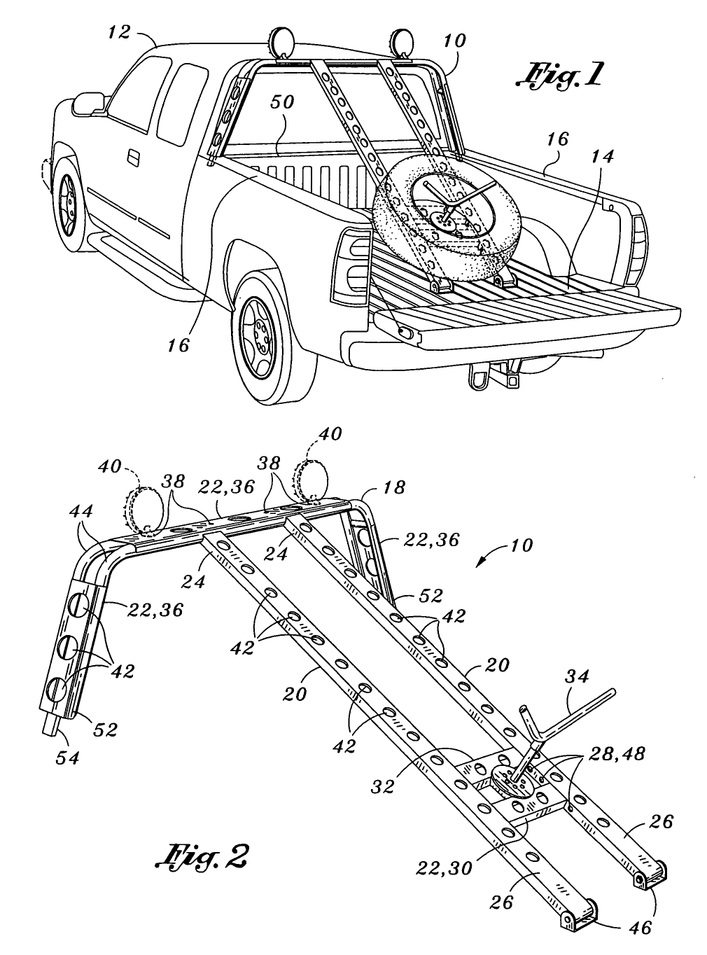

The present invention provides a rack 10 for a vehicle 12 such as a pickup truck as shown in FIG. 1. The vehicle 12 includes a cargo bed 14 and opposing side walls 16. As will become apparent in the description that follows, the rack 10 has a modular construction that allows the rack 10 to be mounted onto a wide variety of vehicles 12 that have cargo beds 14 of varying geometry. Additionally, a user may customize the rack 10 to his/her taste and style. The unique modular design offers an easy installation and the heavy-duty configuration of the rack 10 provides for strength and durability. Furthermore, the rack 10 is relatively lightweight such that it may be easily assembled, mounted onto, and demounted from the vehicle 12.

Referring now to FIG. 2, the rack 10 comprises a frame member 18, a pair of kickers 20, and at least one module 22. As shown in FIG. 1, the frame member 18 may be mountable to the side walls 16 of the vehicle 12. The kickers 20 may each define top and bottom ends 24, 26. The top ends 24 may each be removably connectable to the frame member 18. The top ends 24 may be pivotally or rigidly connectable to the frame member 18. The connection thereof may be made utilizing traditional bolts, pins, or other attachment means such as welding and the like. The bottom ends 26 may each be sized and configured to be removably mountable to the cargo bed 14. It is contemplated that the frame member 18 and the kickers 20 may create a rigid framework through the connection of the frame member 18 to the side walls 16 and the connection of the kickers 20 to the cargo bed 14. The rack 10 may be secured to the vehicle 12 utilizing a variety of means as known by one of skill in the art.

The frame members 18, the kickers 20, and the module 22 may be fabricated from any material such as metal including aluminum, steel or stainless steel. For example, the rack 10 may preferably be constructed from 16 gauge steel. However, other materials such as graphite composite materials and polymeric material (i.e., plastics) may also be used.

The module 22 may be connectable to the frame member 18 or to the kickers 20. The module 22 may also be connectable to both the frame member 18 and the kickers 20. In some implementations, the connection of the module 22 may be effectuated utilizing fasteners such as bolts or pin elements. In other implementations, the module 22, kickers 20, or frame member 18 may be configured to include a mounting mechanism that allows the module 22 to be selectively positioned thereon. Such a mechanism may be fixedly attached to the module 22, the frame member 18, or at least one of the kickers 20. The module 22 may therefore enhance the modularity of the rack 10 because the module 22 may be easily installed and mounted onto the frame member 18 or the kickers 20 without any additional fasteners or mounting devices.

The module 22 may be an optional accessory that may allow the user to enhance the functionality of the rack 10. For example, the module 22 may be a light 40 or light fixture, a storage container such as a tool box, or other various accessories. It is contemplated that any variety of useful accessories may be created and adapted for use with the rack 10. Therefore, in accordance with aspect of the present invention, the module 22 may be variously configured to be utilized one the rack 10 for various applications.

In accordance with another implementation of the present invention, the kickers 20 may further define a plurality of mounting positions 28 between the top and bottom ends 24, 26. It is contemplated that the mounting positions 28 may be configured in numerous patterns according to user requirements. In some embodiments, the mounting positions 28 may include a discrete number of locations whereat the module 22 may be mounted. However, in other embodiments, the mounting positions 28 may not be limited to discrete locations, but may instead be defined as any location along the kickers 20. The module 22 may be positionable at one of the mounting positions 28 and may be removably connectable thereto. The module 22 may also be slidably mountable between the kickers 20 at one of the mounting positions 28. As similarly mentioned above, the connection of the module 22 at one of the mounting positions 28 may be effectuated utilizing fasteners such as bolts or pin elements. Additionally, the module 22 or at least one of the kickers 20 may be configured to include a mounting mechanism that allows the module 22 to be selectively connected thereto. In this regard, the module 22 may be secured at one of the mounting positions 28 without the need for inserting bolts or other fasteners. Such a mechanism may be fixedly attached to one of the module 22 or at least one of the kickers 20. The module 22 may therefore enhance the modularity of the rack 10 because the module 22 may be easily installed and mounted without any additional fasteners or mounting devices.

In certain embodiments of the present invention, as shown in FIGS. 1 and 2, the module 22 may be a tire carrier 30. As illustrated therein, the tire carrier 30 may include a base 32 and a securing element 34 attachable thereto. The base 32 of the tire carrier 30, as described above, may be engageable between the kickers 20 and may be connectable thereto. A spare tire may be mounted onto the tire carrier 30 by placing the tire atop the base 32 and fastening the tire to the base 32 utilizing the securing element 34. The securing element 34 may engage the base 32 through a threaded engagement, as by twisting.

In other embodiments, also shown in FIGS. 1 and 2, the module 22 may be an accessory panel 36 that may be connected to the frame member 18. The accessory panel 36 may include at least one attachment point 38 whereat a light 40 may be affixed. However, the accessory panel 36 may be utilized to accommodate other items such as tools, horns, speakers, and the like. Further, it is contemplated that accessory panels 36 may be mounted to the frame member 18 and may include various designs or other features. For example, as shown in FIG. 2, the accessory panel 36 may include a plurality of apertures 42. Such apertures 42 may serve aesthetic and functional purposes. The apertures 42 may allow the accessory panel 36 to maintain its structural characteristics (which may enhance the overall strength and rigidity of the rack 10), but also allow the accessory panel 36 (and the rack 10 overall) to be more lightweight. Other uses for the accessory panel 36 may be developed according to user requirements.

The frame member 18 may be variously configured. For example, as shown in FIGS. 1 and 2, the frame member 18 may be configured to include a pair of hoops 44 that are positioned parallel relative to each other. The hoops 44 may be of tubular construction. However, the hoops 44 may have a solid core or be of varying cross-sections, as required. In an exemplary embodiment, the accessory panel 36 may be extendable intermediate the hoops 44 and connectable thereto. As indicated above, the frame members 18 may be configured to accommodate various modules 22 according to user requirements.

According to an implementation of the present invention, the kickers 20 may be channeled. The configuration of the kickers 20 may therefore provide maximum strength at a minimal weight, thus increasing several strength properties of the kickers 20 and the rack 10 overall. Similarly to the accessory panel 36, the frame member 18 and the kickers 20 may also each be perforated with a plurality of apertures 42. Thus, it is contemplated that the weight of the individual components of the rack 10 may be decreased by including apertures 42 throughout. Such apertures 42 may be configured to reduce the weight of the component without diminishing its strength properties. Other procedures such as chemical milling or various forming operations are contemplated alternatives to maintain strength while lessening the weight of the component.

In mounting the kickers 20, the bottom ends 26 thereof may be connectable to the cargo bed 14 utilizing standard fasteners as known in the art. As shown in FIG. 2, the kickers 20 may also be configured to include a pair of base brackets 46 disposed at the bottom ends 26 thereof. Each of the base brackets 46 may be connectable to the bottom ends 26 of the kickers 20 and may be mountable to the cargo bed 14. The base brackets 46 may also be mountable to the cargo bed 14 utilizing standard fasteners as known in the art.

In accordance with another embodiment of the present invention, a modular rack 10 is provided that is mountable to a vehicle 12. As mentioned above, the vehicle 12 includes a cargo bed 14 and opposing side walls 16. The rack 10 comprises a frame member 18, a pair of kickers 20, and a tire carrier 30. The frame member 18 may be mountable to the side walls 16. The pair of kickers 20 may each define a top end 24, a bottom end 26, and a plurality of mounting positions 28 between the top and bottom ends 24, 26. The top ends 24 may each be removably connectable to the frame member 18, and the bottom ends 26 may each be removably mountable to the cargo bed 14. The tire carrier 30 may be selectively positionable between the kickers 20 at one of the mounting positions 28 and being removably connectable thereto.

As mentioned above, it is contemplated that the mounting positions 28 may be configured in numerous patterns according to user requirements. In some embodiments, the mounting positions 28 may include a discrete number of locations whereat the module 22 may be mounted. In this regard, the mounting positions 28 may be defined by a plurality of adjustment holes 48. Thus, the tire carrier 30 is connectable to the kickers 20 utilizing the adjustment holes 48. The tire carrier 30 may be connected to the kickers 20 utilizing fasteners disposable through the adjustment holes 48. Such fasteners may include bolts, lock pins, and the like. As also mentioned above, in other embodiments, the mounting positions 28 may not be limited to discrete locations, but may instead be defined as any location along the kickers 20. Thus, the tire carrier 30 may be connectable to the kickers 20 utilizing a press-fit or other suitable mechanism that may facilitate connection thereof at any location along the kickers 20. As also discussed above, the kickers 20 and other components of the rack 10 may be variously configured to include channels and the like for improving strength properties and decreasing overall weight.

In accordance with another aspect of the present invention, the cargo bed 14 may include a front wall 50 interposed between the side walls 16 and the frame member 18 may be vertically positioned adjacent the front wall 50. The frame member 18, as shown in FIG. 1, may be positioned directly above the front wall 50. However, it is also contemplated that the frame member 18 may be positioned at various other locations along the side walls 16.

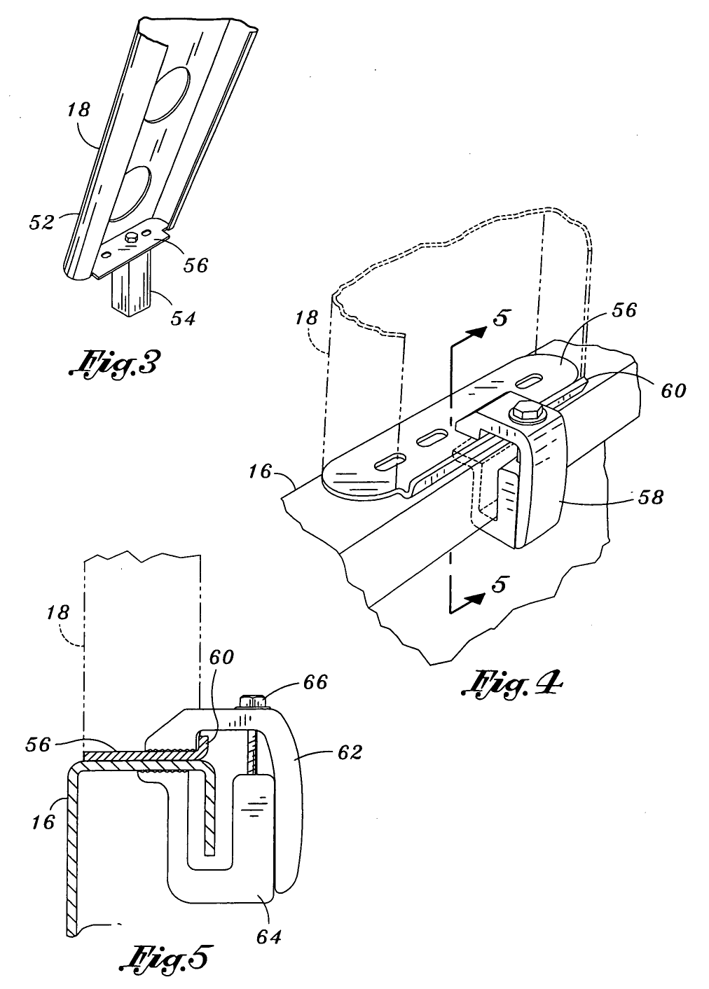

Many vehicles 12 such as pickup trucks typically feature stake holes formed through top surfaces of the side walls 16. Embodiments of the present invention exploit this feature to facilitate connection of the frame member 18 to the side walls 16. Referring to FIG. 3, the frame member 18 may define opposing ends 52 and may include a pair of stake mounts 54 extending downwardly from the opposing ends 52. By simply inserting the stake mount 54 into a corresponding one of the stake holes, the frame member 18 may be mounted to the vehicle 12.

As illustrated in FIGS. 4 and 5, in an additional mechanism for mounting the frame member 18, the frame member 18 may also include a pair of base plates 56 disposable at opposing ends 52 of the frame member 18 and rigidly connectable thereto. The frame member 18 may further include a pair of clamps 58 extending over the respective ones of the base plates 56 and being sized and configured to clamp the base plates 56 to the side walls 16. In some embodiments, the base plates 56 may each include a lip 60 protruding perpendicularly therefrom. As shown in FIG. 5, the clamps 58 may utilize the lip 60 of the base plates 56 by being C-shaped and being sized and configured to extend over the lip 60 and to clamp 58 the base plates 56 to the side walls 16. The clamp 58 may include a lower clamp member 62 and an upper clamp member 64 which may be fastened together using a fastening element 66 such as a bolt or screw that passes through the upper clamp member 64 and which is threadably engaged to a threaded hole in the lower clamp member 62. Clamping of the base plate 56 and side wall 16 between the lower and upper clamp members 62, 64 may be performed by tightening the bolt. Therefore, the lower and upper clamp members 62, 64 may be adjustable relative to each other with at least a portion of the side wall 16 and at least a portion of the base plate 56 being capturable between the lower and upper clamp members 62, 64.

In accordance with yet another embodiment of the present invention, a rack 10 is provided that is mountable to a vehicle 12. The vehicle 12 includes a front wall 50, a cargo bed 14 and opposing side walls 16. The rack 10 comprises a frame member 18, at least two channeled kickers 20, a pair of base brackets 46, and at least one module 22. The frame member 18 may be mountable to the vehicle 12 over the front wall 50 and extendable between the side walls 16. The channeled kickers 20 may each define top and bottom ends 24, 26. The top ends 24 may each be removably connectable to the frame member 18, and the bottom ends 26 may each be removably mountable to the cargo bed 14. The base brackets 46 may be connectable to the kickers 20 at the respective bottom ends 26 thereof and may be mountable to the cargo bed 14. The module 22 may be connectable to one of the frame member 18 and the kickers 20.

As discussed previously, the kickers 20 may define a plurality of mounting positions 28 between the top and bottom ends 24, 26 thereof, and the module 22 may be positionable at one of the mounting positions 28 and be removably connectable thereto. Additionally, the mounting positions 28 may be defined by a plurality of adjustment holes 48. As also mentioned above, the module 22 may be variously configured, and may be a tire carrier 30, an accessory panel 36, or other devices that may be connectable to the kickers 20 and/or to the frame member 18.

In order to facilitate fit and use of the rack 10, it is also contemplated that the rack 10 may be modified to include other elements such as rubber gaskets, washers, and the like. Thus, at least one rubber gaskets may be interposed between each one of the base plates 56 and the side walls 16 in order to prevent scratching, reduce noise, and enhance the fit of the rack 10 on the vehicle 12. Other modifications and elements may be included to enhance other uses of the rack 10. The rack 10 may therefore be variously modified according to user requirements and adaptations of existing or future apparatuses.

The above description is given by way of example, and not limitation. As mentioned above, one skilled in the art could devise variations that are within the scope of the invention disclosed herein, including various ways of manufacturing, installing, and utilizing the rack 10. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A modular rack mountable to a vehicle, the vehicle including a cargo bed and opposing side walls, the rack comprising:
a) a frame member mountable to the side walls; and
b) a pair of kickers each defining top and bottom ends, the top ends each being removably connectable to the frame member and the bottom ends each being removably mountable to the cargo bed; and
c) at least one module being connectable to one of the frame member and the kickers.

2. The rack of claim 1 wherein the kickers further define a plurality of mounting positions between the top and bottom ends, the module being positionable at one of the mounting positions and being removably connectable thereto.

3. The rack of claim 1 wherein the module is a tire carrier.

4. The rack of claim 1 wherein the module is an accessory panel being connectable to the frame member.

5. The rack of claim 4 wherein the frame member includes a pair of hoops being positioned parallel relative to each other and the accessory panel is extendable intermediate the hoops and connectable thereto.

6. The rack of claim 1 wherein the kickers are channeled.

7. The rack of claim 1 wherein the kickers include a pair of base brackets disposed at the bottom ends thereof, the base brackets being connectable to the bottom ends of the kickers and being mountable to the cargo bed.

8. The rack of claim 1, wherein the frame member and the kickers are each perforated with a plurality of apertures.

9. A modular rack mountable to a vehicle, the vehicle including a cargo bed and opposing side walls, the rack comprising:
a) a frame member mountable to the side walls;
b) a pair of kickers each defining a top end, a bottom end, and a plurality of mounting positions between the top and bottom ends, the top ends each being removably connectable to the frame member and the bottom ends each being removably mountable to the cargo bed; and
c) a tire carrier being selectively positionable between the kickers at one of the mounting positions and being removably connectable thereto.

10. The rack of claim 9 wherein the mounting positions are defined by a plurality of adjustment holes.

11. The rack of claim 9 wherein the kickers are channeled.

12. The rack of claim 9 wherein the cargo bed includes a front wall interposed between the side walls, the frame member being vertically positioned adjacent the front wall.

13. The rack of claim 9, wherein the frame member defines opposing ends and includes a pair of stake mounts extending downwardly from the opposing ends.

14. The rack of claim 9, wherein the frame member includes:
a) a pair of base plates disposed at opposing ends of the frame member and being rigidly connectable thereto; and
b) a pair of clamps extending over the respective ones of the base plates and being sized and configured to clamp the base plates to the side walls.

15. The rack of claim 14, wherein the base plates each include a lip protruding perpendicularly therefrom and the clamps are C-shaped, the clamps being sized and configured to extend over the lip and to clamp the base plates to the side walls.

16. The rack of claim 15, wherein each one of the C-shaped clamps includes upper and lower clamp members being connectable to each other, the upper and lower clamp members being adjustable relative to each other with at least a portion of the side wall and at least a portion of the base plate being capturable between the upper and lower clamp members.

17. A rack mountable to a vehicle, the vehicle including a front wall, a cargo bed and opposing side walls, the rack comprising:
a) a frame member being mountable to the vehicle over the front wall and extendable between the side walls;
b) at least two channeled kickers each defining top and bottom ends, the top ends each being removably connectable to the frame member and the bottom ends each being removably mountable to the cargo bed; and
c) a pair of base brackets being connectable to the kickers at the respective bottom ends thereof, the base brackets being mountable to the cargo bed; and
d) at least one module being connectable to one of the frame member and the kickers.

18. The rack of claim 17 wherein the kickers further define a plurality of mounting positions between the top and bottom ends, the module being positionable at one of the mounting positions and being removably connectable thereto.

19. The rack of claim 17 wherein the module is a tire carrier.

20. The rack of claim 17 wherein the module is an accessory panel being connectable to the frame member.
